(19) United States
(12) Patent Application Publication
(10) Pub. No.: US 2019/0309197 A1
(43) Pub. Date: Oct. 10, 2019

(54) THERMAL ADHESIVE CONTAINING TETRAPOD ZINC OXIDE AND ALUMINA NANOFIBER

(71) Applicant: YOUNGYIEL PRECISION CO., LTD., Seoul (KR)

(72) Inventors: Jae-Uk CHU, Seoul (KR); Chang-Kook JANG, Gyeonggi-do (KR); Seon-Ja SONG, Seoul (KR); Seung-Won SONG, Seoul (KR)

(21) Appl. No.: 16/373,280

(22) Filed: Apr. 2, 2019

(30) Foreign Application Priority Data
Apr. 6, 2018 (KR) 10-2018-0040094

(51) Int. Cl. C09J 163/00; C09J 11/04; C08K 3/22; C08K 3/38; C08K 3/28; C08K 7/08

(52) U.S. Cl. CPC C09J 163/00; C09J 11/04; C08K 3/22; C08K 3/38; C08K 3/28; C08K 2201/011; C08K 2003/2296; C08K 2003/2227; C08K 2003/385; C08K 2003/282; C08K 7/08

(57) ABSTRACT

A thermal adhesive containing a resin component includes an epoxy resin and an inorganic filler, where the inorganic filler includes tetrapod zinc oxide and alumina nanofiber, where the inorganic filler may further include at least one selected from among spherical alumina, AlN and BN, and where the resin component may further include a curing agent and a catalyst.

### BACKGROUND OF THE INVENTION

### 1. Technical Field

The present invention relates to a thermal adhesive, particularly a thermal adhesive composition having superior heat conductivity compared to conventional thermal adhesives. More particularly, the present invention relates to an inorganic filler, which is responsible for heat transfer, among the components of a thermal adhesive.

### 2. Description of the Related Art

A thermal adhesive functions as an adhesive and also has a heat dissipation function. A thermal adhesive may be used in various product fields, but the following description will be made by taking an LED as an example.

An LED lamp, which is a light source element, is a type of diode that emits light when current flows. Initially there were limitations of low luminance and difficulty in color implementation, but now, it is possible to realize all colors of visible light including white by virtue of new light-emitting diode materials and advanced production technology. Such light-emitting diodes having high luminance, high efficiency, and various colors have already been widely applied to large-sized electric sign boards, emergency lights, traffic signals and the like. A conventional LED heat dissipation structure is configured so as to dissipate heat to the outside through the large area of the back surface of a metal plate in a manner in which most of the heat generated from an LED lamp is transferred to the connection portion on a circuit board through a heat sink slug inserted in an LED housing, and is also conducted to the metal plate having excellent heat conductivity, such as an iron plate, under the circuit board. Such a structure uses a metal having excellent heat conductivity, so that the heat generated in a region where LED lamps are intensively arranged may be conducted and diffused to the entire surface of the metal plate within a short time, and thus the amount of heat generated per unit area may be reduced, but there is a limitation on the extent to which the coefficient of heat conduction of the conventional metal, having excellent heat conductivity, may be improved. Thermal adhesives are widely used for bonding LED light-emitting devices and the like, which generate large amounts of heat, onto a printed circuit board. Conventional thermal adhesives are mainly prepared by adding a binder, an organic solvent, and an additive to a powder (inorganic filler) having heat dissipation properties and mixing them in a paste phase.

With regard to the conventional thermal adhesive, Korean Patent Application Publication No. 10-2018-0022714 discloses a composition for a thermal adhesive, comprising an epoxy resin, a curing agent, and an inorganic filler, and having a complex viscosity of 1×10³ Pa·s to 5×10⁶ Pa·s at 80° C.

Also, Korean Patent No. 10-1732965 discloses a high thermal silver paste, comprising 100 parts by weight of a first silver sol containing a micro-sized silver powder having a particle size of 1 to 4 μm, the surface of which is coated with a dispersant, 20 to 30 parts by weight of a second silver sol containing a nano-sized silver powder having a particle size of 200 to 600 nm, the surface of which is coated with a dispersant different from the coating of the first silver sol, 5 to 10 parts by weight of an epoxy resin having an epoxy equivalent of 150 to 200, and 0.1 to 0.3 parts by weight of a thermal curing agent.

Also, Korean Patent No. 10-1704728 discloses a high thermal adhesive composition containing ultrasonic-modified expanded graphite.

Also, Korean Patent No. 10-1324481 discloses a thermal adhesive composition comprising a main material and a curing agent, which are mixed together, the main material including alumina, a reaction product of bisphenol A and epichlorohydrin, an additive, and an organic solvent.

### SUMMARY OF THE INVENTION

Accordingly, the present invention is intended to provide a thermal adhesive, which may exhibit a superior heat dissipation effect even when used in a small amount.

In particular, the present invention is intended to provide a thermal adhesive having high heat conductivity through a novel inorganic filler combination.

In particular, the present invention is intended to provide a thermal adhesive having high heat conductivity through a combination of two or more inorganic fillers.

The present invention provides a thermal adhesive comprising a resin component including an epoxy resin and an inorganic filler, in which the inorganic filler includes tetrapod zinc oxide and alumina nanofiber.

In particular, the inorganic filler may further include at least one selected from among spherical alumina, AlN and BN.

In particular, the AlN and the BN may be AlN nanofiber and BN nanofiber, respectively.

In particular, the resin component may further include a curing agent and a catalyst.

In particular, the resin component may further include at least one of a defoaming agent and a dispersant.

In particular, the inorganic filler may be used in an amount of 70 to 95 wt % based on the total weight of the thermal adhesive.

In particular, the total amount of the tetrapod zinc oxide and the alumina nanofiber may be 1 to 10 wt % based on the total weight of the thermal adhesive.

A thermal adhesive, prepared by the method of the present invention, can exhibit very high heat conductivity even when small amounts of tetrapod zinc oxide and alumina nanofiber are contained. For example, the heat conductivity can be confirmed to increase about 2 to 4 times in Examples of the present invention compared to the Comparative Example. This increase in heat conductivity is particularly meaningful because there is no need to use large amounts of tetrapod zinc oxide and aluminum nanofiber.

### DETAILED DESCRIPTION OF THE INVENTION

The present invention pertains to a thermal adhesive containing a resin component including epoxy and an inorganic filler.

In the present invention, the resin component essentially includes an epoxy resin, and may further include a curing agent (polyetheramine, etc.), a catalyst, a defoaming agent and a dispersant.

In the present invention, the inorganic filler may include tetrapod zinc oxide and alumina nanofiber.

Tetrapod zinc oxide (T-ZnO) is zinc oxide having four bridges, and may be prepared by heating Zn powder to 800° C. or higher in the presence of oxygen. Tetrapod zinc oxide enables efficient heat transfer in the inorganic filler due to a specific bridge structure in the thermal adhesive according to the present invention.

Alumina nanofiber (nanotube) has high adsorption capability and is thus used as an adsorbent for the preparation of technetium-99m that is an isotope for cancer diagnosis, but is employed as an inorganic filler in the present invention. The alumina nanofiber may be prepared through electrospinning or by bringing an electrolyte aqueous solution such as sodium chloride into contact with an aluminum metal electrode at a voltage of 5˜15V. The alumina nanofiber is conventionally well-known, and thus, in the present invention, a description of a method of preparing the alumina nanofiber is omitted. In the present invention, the alumina nanofiber enables efficient heat transfer by virtue of the tube structure thereof.

The present inventors have ascertained that when both tetrapod zinc oxide and alumina nanofiber are used as inorganic filler, heat conductivity may be increased, thus culminating in the present invention.

In the present invention, the inorganic filler may include typical inorganic fillers such as AlN, BN and spherical alumina (in the present invention, “spherical alumina” means typical alumina, rather than “alumina nanofiber”), and AlN and BN may be nanofiber (nanotube). Particularly, in the present invention, it was confirmed through preliminary experimentation that, even when typical inorganic filler is added with small amounts of tetrapod zinc oxide and alumina nanofiber, the heat conductivity is increased to a very high level. Hence, in the following examples, expensive tetrapod zinc oxide or alumina nanofiber was used in a small amount. The inorganic filler is preferably contained in an amount of 70 to 95 wt % based on the total weight of the thermal adhesive. If necessary, however, it may be used in an amount falling out of the above range.

Below, five thermal adhesive samples, namely Comparative Example and Examples 1 to 4, were prepared, and the heat conductivities thereof were compared and tested.

### COMPARATIVE EXAMPLE

TABLE 1

| | | | | | Heat |
|---|---|---|---|---|---|
| | | | Size | | conductivity |
| | | Shape | (μm) | Amount | (W/mK) |
| Filler | Al₂O₃ | Spherical | 10~20 | 87.3 | 4.95 |
| | AlN | Spherical | 30 | 2.37 | |
| | BN | Amorphous | 0.5 | 3.75 | |

| | |
|---|---|
| Resin | 6.58 |
| (Epoxy + Curing agent + Catalyst) | |

Comparative Example is a conventional thermal adhesive containing neither tetrapod zinc oxide nor alumina nanofiber. As epoxy, DER 732 available from Dow Chemical, as a curing agent, JEFFAMINE T-403 (a polyetheramine-based compound) available from HUNTSMAN, and as a catalyst JEFFCAT® ZF-20 (bis-(2-dimethylaminoethyl)ether) available from HUNTSMAN were used. Trace amounts of dispersant and defoaming agent were added to the thermal adhesive. Also, in the following examples, the same resin component was applied. The heat conductivity was measured using a DynTIM made by GE.

The heat conductivity of the thermal adhesive of Comparative Example was measured to be 4.95 W/mK.

### Example 1

TABLE 2

| | | | | | Heat |
|---|---|---|---|---|---|
| | | | Size | | conductivity |
| | | Shape | (μm) | Amount | (W/mK) |
| Filler | Al₂O₃ | Spherical | 10~20 | 84.3 | 9.56 |
| | AlN | Spherical | 30 | 2.37 | |
| | BN | Amorphous | 0.5 | 3.75 | |
| | Al₂O₃ nanofiber | Tube | | 0.75 | |
| | T-ZnO | Tetrapod | | 2.25 | |

| | |
|---|---|
| Resin | 6.58 |

In Example 1, a thermal adhesive was prepared by further adding tetrapod zinc oxide, obtained by placing Zn/carbon in an oven at 1000 to 1400° C. and sintering it for 2 to 10 hr, and alumina nanofiber having a diameter of 2 to 5 nm, a length of 200 to 500 nm and a high aspect ratio of 40 to 100, in the above amounts.

The heat conductivity of the thermal adhesive of Example 1 was measured to be 9.56 W/mK, which was approximately double that of Comparative Example.

### Example 2

TABLE 3

| | | | | | Heat |
|---|---|---|---|---|---|
| | | | Size | | conductivity |
| | | Shape | (μm) | Amount | (W/mK) |
| Filler | Al₂O₃ | Spherical | 10~20 | 84.3 | 11.87 |
| | AlN | Spherical | 30 | 2.37 | |
| | BN | Amorphous | 0.5 | 2.25 | |
| | Al₂O₃ nanofiber | Tube | | 0.75 | |
| | T-ZnO | Tetrapod | | 2.25 | |

| | |
|---|---|
| Resin | 8.08 |

In Example 2, a thermal adhesive was prepared by decreasing the amount of BN, unlike Example 1. When the amount of BN is decreased in this way, the dispersivity of tetrapod zinc oxide and alumina nanofiber is considered to increase.

Consequently, the heat conductivity thereof was measured to be 11.87 W/mK, which was much higher than that of Comparative Example and higher than that of Example 1.

### Example 3

TABLE 4

| | | | | | Heat |
|---|---|---|---|---|---|
| | | | Size | | conductivity |
| | | Shape | (μm) | Amount | (W/mK) |
| Filler | Al₂O₃ | Spherical | 10~20 | 84.3 | 15.58 |
| | AlN | Spherical | 30 | 2.37 | |
| | BN | Amorphous | 0.5 | 0.75 | |
| | Al₂O₃ nanofiber | Tube | | 0.75 | |
| | T-ZnO | Tetrapod | | 2.25 | |

| | |
|---|---|
| Resin | 9.58 |

In Example 3, a thermal adhesive was prepared by further decreasing the amount of BN, compared to Example 2. Consequently, the heat conductivity thereof was measured to be 15.58 W/mK, which was much higher than that of Comparative Example and was somewhat higher than that of Example 1.

### Example 4

TABLE 5

| | | | | | Heat |
|---|---|---|---|---|---|
| | | | Size | | conductivity |
| | | Shape | (μm) | Amount | (W/mK) |
| Filler | Al₂O₃ | Spherical | 10~20 | 84.3 | 16.5 |
| | AlN | Spherical | 30 | 2.37 | |
| | BN | Amorphous | 0.5 | 0.75 | |
| | Al₂O₃ nanofiber | Tube | | 0.75 | |
| | T-ZnO | Tetrapod | | 3.0 | |

| | |
|---|---|
| Resin | 8.83 |

In Example 4, a thermal adhesive was prepared by increasing the amount of tetrapod zinc oxide, compared to Example 3. Consequently, the heat conductivity thereof was increased to 16.5 W/mK.

Based on the test results of Examples, even when tetrapod zinc oxide and alumina nanofiber are used in small amounts in the present invention, very high heat conductivity can be concluded to result. Taking into consideration the price and physical properties, even when the total amount of alumina nanofiber and tetrapod zinc oxide is 10 wt % or less, for example, 1 to 10 wt %, based on the total weight of the thermal adhesive, high heat conductivity can be obtained.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A thermal adhesive, comprising a resin component including an epoxy resin and an inorganic filler,
wherein the inorganic filler includes tetrapod zinc oxide and an alumina nanofiber.

2. The thermal adhesive of claim 1, wherein the inorganic filler further includes at least one selected from among spherical alumina, AlN and BN.

3. The thermal adhesive of claim 2, wherein the AlN and the BN are an AlN nanofiber and a BN nanofiber.

4. The thermal adhesive of claim 1, wherein the resin component further includes a curing agent and a catalyst.

5. The thermal adhesive of claim 1, wherein the resin component further includes at least one of a defoaming agent and a dispersant.

6. The thermal adhesive of claim 1, wherein the inorganic filler is contained in an amount of 70 to 95 wt % based on a total weight of the thermal adhesive.

7. The thermal adhesive of claim 1, wherein a total amount of the tetrapod zinc oxide and the alumina nanofiber is 1 to 10 wt % based on a total weight of the thermal adhesive.
